(19) United States
(12) Patent Application Publication
(10) Pub. No.: US 2025/0031704 A1
(43) Pub. Date: Jan. 30, 2025

(54) Food Flavor Processor

(71) Applicant: Lumos Technology Co., Ltd., Taipei (TW)

(72) Inventor: Chih-Yi Yang, Taipei (TW)

(21) Appl. No.: 18/710,582

(22) PCT Filed: Dec. 14, 2022
(86) PCT No.: PCT/CN2022/138879

§ 371 Date: May 15, 2024

Related U.S. Application Data
(60) Provisional application No. 63/290,631, filed on Dec. 16, 2021.

(51) Int. Cl. A21B 3/04; A21B 1/26

(52) U.S. Cl. CPC A21B 3/04; A21B 1/26

(57) ABSTRACT

Provided is a food flavor processor for a user to heat the surface of a food material at least having protein and/or carbohydrates. The food flavor processor comprises: a base apparatus; an airflow driving apparatus for driving a gas to flow towards the surface of the food material; a media dispersing apparatus provided on the base apparatus for dispersing and mixing the flowing gas and a medium with a specific heat capacity higher than that of the gas into a mixed fluid; and a heating apparatus provided on the base apparatus for heating the flowing gas, the medium or the mixed fluid to between at least 100 and 200 degrees Celsius, thereby adding flavor to the surface of the food material.

### FIELD

The subject matter described herein relates to a food heating tool, and more particularly relates to flavor-adding kitchenware.

### BACKGROUND

Archaeologists hypothesize that, the forests where early humans lived were frequently stricken by lightning with a fire caused, and after the fire extinguished, the early humans would return to their original habitats, smelling the appetizing aroma of seared animal corpses, tasting the flame-seared animal meat, and finding it far more tasty than raw meat; later, the humans mastered the skill of making fire and started a life of cooking and eating cooked food. The cooked food is tasty, and more importantly has bacteria killed off. Since then, the humans' cooking techniques have been constantly evolved and improved, with various regional styles developed.

Among various cooking methods, some methods bring out more abundant colors, aromas, and tastes. For example, compared with poaching/steaming, barbecuing/frying renders more peculiar flavors and tastes. For typical food searing, a food ingredient may be directly exposed to the flame resulting from combustion of charcoal or gas, or baked in an oven or by hot air; if the heating temperature reaches between 140° C. and 170° C., a Maillard reaction would occur to the heated surface of the ingredient. The Maillard reaction refers to a cascade of complex interactions between reducing sugars (carbohydrates) and amino acids during cooking at a normal or heated temperature, and the dark brownish macromolecular substance Melanoidin produced therefrom contributes an appetizing color to the food, e.g., a golden-brown crust on bread. During the Maillard reaction, hundreds of flavor compounds are generated, which in turn give rise to more species of complex compounds, including reducing aldehydes/ketones and heterocyclic compounds. Each type of food would form unique flavor compounds from the Mallard reaction, which give pleasant flavors and appetizing colors to the food. However, without appropriate control of the temperature, e.g., heated above 200° C., carcinogenic by-products such as acrylamide would be formed. Therefore, it is of a health concern how to heat food appropriately so as to stably produce a Mallard reaction without being over-heated or burnt. On the other hand, a caramelization reaction likely occurs under a similar temperature range if a food ingredient contains purely carbohydrates is heated, which may also change the flavor of the surface of food ingredient.

In the current market, a cooker usually uses a gas torch 7 (shown in FIG. 1) to fast sear a food ingredient, e.g., a hand-roll sushi or a caramel custard, or to finish sous vide meat. The gas torch 7 creates a very high temperature, the flame tip of which may exceed 1,000° C., so that it can quickly produce a Mailliard reaction or caramelization reaction on the surface of the food ingredient, contributing a unique aroma, a crispy surface, or a somewhat heated effect. However, since the flame blown thereby has a very high temperature, an unskilled cooker would easily burn the ingredient surface causing carcinogenic by-products. It is usually a difficult job to give an appropriate control of a effective to-surface distance and a heating duration; what's worse, a bad smell may be left on the surface of the food ingredient due to incomplete gas combustion. Special care is also needed when using open flame.

Compared with the gas torch 7, an oven or an air fryer is a safer heating option. However, it is difficult to control the oven's heating temperature and duration. For one who wants a local seared effect in short time, low and slow roasting would cause loss of moisture inside the food ingredient, while high-temperature searing is demanding on the distance between the food ingredient and the heat source, as well as precise control of heating duration; otherwise, a burnt or undesired effect would easily occur. Generally speaking, the oven and the air fryer are more preferred for heating an entire food ingredient, not suitable for surface searing. Therefore, it is desired in the art to provide a convenient tool which heats the surface of a food ingredient appropriately to promote Maillard reaction for giving a unique flavor while avoiding overheat from producing substances detrimental to human health.

### SUMMARY

An objective of the disclosure is to provide flavor-adding kitchenware, which heats a surface of a food ingredient to a temperature ranging from 140° C. to 170° C. and hold the temperature for a certain duration to give rise to a Maillard reaction/caramelization reaction, whereby food flavor is enhanced while unnecessary burning is prevented.

Another objective of the disclosure is to provide flavor-adding kitchenware, which increases the specific heat capacity of a medium by heating a gas and/or an edible medium (e.g., water, edible oil) and sprays the heated medium on a surface of a food ingredient to give effective heating.

A further objective of the disclosure is to provide flavor-adding kitchenware, which diffuses a heat transfer medium via a medium diffuser, so that by spraying the diffused medium on a surface of a food ingredient, the food ingredient may be heated homogeneously.

A still further objective of the disclosure is to provide flavor-adding kitchenware, which facilitates a user to use by adopting a replaceable, detachable medium storage and also facilitates changing an appropriate edible medium based on a different food ingredient.

A yet further objective of the disclosure is to provide flavor-adding kitchenware, which adds an additional flavor to a food ingredient during cooking by mixing spicery into an edible medium or by spraying spicery carried in a gas flow onto a surface of the food ingredient via a spicery releasing port.

A still yet objective of the disclosure is to provide flavor-adding kitchenware, which optimizes food heating performance using an outlet temperature sensor to measure an outlet temperature of a mixed fluid.

Flavor-adding kitchenware according to the disclosure is available for a user to heat a surface of an ingredient having proteins and/or carbohydrates, the flavor-adding kitchenware comprising: a base; a gas flow driver operable to drive a gas to flow toward the surface of the food ingredient; a medium diffuser disposed at the base, operable to diffuse a medium whose specific heat capacity is higher than the gas and mix the medium with the gas which is flowing to form a mixed fluid; and a heater disposed at the base, operable to heat the gas which is flowing, the medium, or the mixed fluid, till a temperature ranging from 100° C. to 200° C. to contribute a flavor to the surface of the food ingredient.

The flavor-adding kitchenware described herein heats a gas and/or an edible medium via a heater to a temperature of at least above 100° C., and blows, to a food ingredient, a gas flow which is generated by the gas flow driver and carries a mixed fluid formed by mix of the gas and the edible medium using the medium diffuser; since the medium or the mixed fluid has been heated appropriately, the surface of the food ingredient can be homogeneously heated till a temperature creating a Maillard reaction or caramelization reaction; furthermore, since the edible medium significantly increases the specific heat capacity of the mixed fluid, excessive heating is prevented from burning the food ingredient; in need of adding an extra flavor, soluble spicery may be added to the medium, or the spicery is filled in the spicery canister and homogeneously sprayed on the surface of the food ingredient after being carried in the mixed gas flow via the spicery releasing port; the heating temperature may be adjusted via the controller dependent on different food ingredients or different favors of individual users. As such, the disclosure provides an easily operable, safe, hygienic, Maillard reaction-enabled heating method for heating surfaces of various types of food ingredients, overcoming the drawbacks mentioned supra.

### BRIEF DESCRIPTION OF THE DRAWINGS

FIG. 1 is a schematic diagram of a conventional technology;

FIG. 2 is a stereoscopic diagram of flavor-adding kitchenware according to a first implementation of the disclosure;

FIG. 3 is a schematic diagram of the flavor-adding kitchenware according to the first implementation of the disclosure;

FIG. 4 is a schematic diagram of flavor-adding kitchenware according to a second implementation of the disclosure;

FIG. 5 is a schematic diagram of flavor-adding kitchenware according to a third implementation of the disclosure;

FIG. 6 is a schematic diagram of flavor-adding kitchenware according to a fourth implementation of the disclosure;

FIG. 7 is a schematic diagram of flavor-adding kitchenware according to a third implementation of the disclosure.

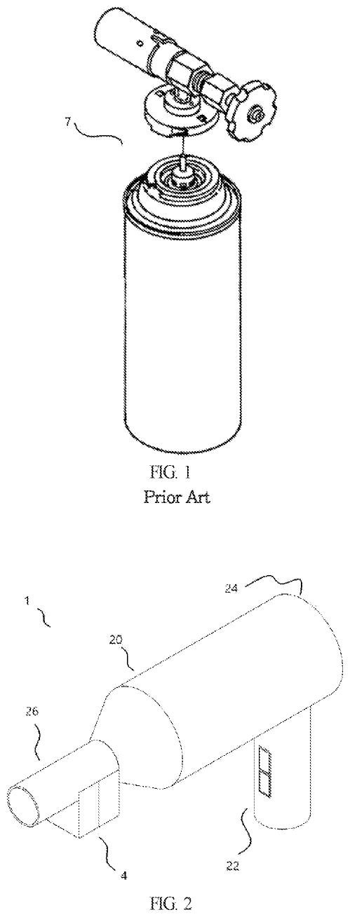

### DETAILED DESCRIPTION OF EMBODIMENTS

The technical contents, characteristics, and effects of the disclosure may become apparent through detailed illustration of implementations with reference to the accompanying drawings; same or like elements are represented by similar reference numerals throughout the implementations.

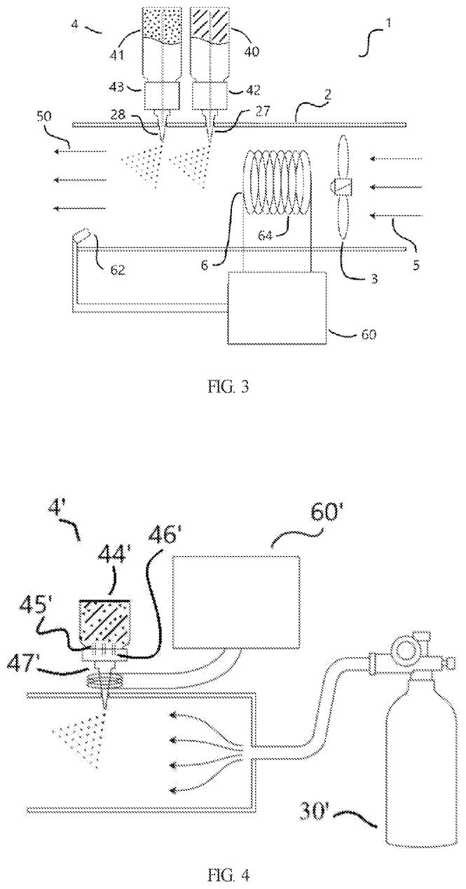

FIGS. 2 and 3 illustrate flavor-adding kitchenware 1 according to a first implementation of the disclosure. The flavor-adding kitchenware 1 comprises a base 2. In this implementation, the base 2 has a gas duct 20 of a cylindrical shape and a handle 22 connected underneath the gas duct; openings are formed at both of front and rear ends of the gas duct 20, so that a gas channel 24 is formed in a fore-and-aft direction; a narrowed opening portion 26 is formed on the left side of the gas duct 20. A gas flow driver 3, for example an axial-flow fan, is mounted in the gas channel 24. Of course, those skilled in the art may readily understand that the gas flow driver 3 may also be a blower fan or another equivalent structure in some other implementations. When the gas flow driver 3 is activated, a gas 5 in the gas channel 24 forms a gas flow from rear to front. In this implementation, the gas flow is formed by intaking air from an external air inlet disposed at the rear side, which flows out towards a downstream outlet along the gas duct 20 and is blown to the surface of a food ingredient.

A heater 6 disposed downstream of the gas flow driver 3 is provided in the base 2. In this implementation, the heater 6 is exemplarily an electric heater 64. The electric heater 64 may directly heat air molecules in the gas 5 to a temperature ranging from about 200° C. to about 250° C., the temperature of the electric heater 64 being controlled by a controller 60 in electrical connection thereto. The gas duct 20 is further provided with at least one medium spout 27 and at least one spicery releasing port 28 which are located downstream of the heater 6. A medium diffuser 4 is disposed downstream of the heater 6. In this implementation, the medium diffuser 4 being partitioned into a medium canister 42 filled with an edible medium 40 and a spicery canister 43, the medium canister 42 corresponding to the medium spout 27, the spicery canister 43 corresponding to the spicery releasing port 28. In this implementation, the medium 40 is an edible oil with a high smoke point, e.g., avocado oil; of course, a person with normal cooking or food knowledge would appreciate that a user may select another appropriate medium as the heat transfer medium dependent on a specific food ingredient to cook or his/her personal favor, while a powder or solution comprising particles of spicery 41 may also be discretionally selected by the user. In this disclosure, Italian mixed spicery available in the market is taken as an example.

In this implementation, the edible oil as the medium is accumulated at the bottom of the medium canister 42 along the direction of gravity. Therefore, in this implementation, when the heated gas 5 flows through the medium diffuser 4, the edible oil (e.g., the avocado oil) and spicery (e.g., the Italian mixed spicery) powders in the edible oil, which originally cannot fall off directly due to cohesion forces, pass through the narrowed medium spout 27 and spicery releasing port 28 under the pressure difference generated according to the Bernoulli's principle when the gas flow passes, and are introduced in the gas 5 and homogenously distributed therein, thereby being further mixed with the gas 5 to form a mixed fluid 50. Introduction of the avocado oil may effectively increase the specific heat capacity of the mixed fluid 50 while avoiding the mixed fluid 50 from being heated to above 200° C.; as such, when the mixed fluid 50 is blown to the surface of the food ingredient, the temperature on the surface of the food ingredient may rise to induce a Maillard reaction or caramelization reaction, without overheating to cause an undesired burnt effect; in addition, the Italian mixed spicery can add a flavor to the overall ingredient.

In this implementation, an outlet temperature sensor 62 is further provided at an outlet of the base 2, the outlet temperature sensor 62 being operable to provide a real-time outlet temperature feedback; during working, temperature adjustment is enabled by the controller 60 based on real-time information of the outlet temperature sensor 62; the outlet temperature sensor 62 may effectively avoid impacts from external conditions such as air temperature. In some other implementations, the controller 60 may also be electrically connected to the gas flow driver 3 so as to control a rate of the gas flow formed by the gas 5, whereby the overall heating performance is optimized. A normal use process according to the first implementation comprises: selecting a food ingredient that has been appropriately preprocessed, e.g., nigiri sushi, sous vide meat, caramel custard, etc.; selecting appropriate spicery 41 and medium 40 based on the food ingredient, and filling them in the spicery canister 43 and the medium canister 42, respectively; activating the gas flow driver 3 and the heater 6, waiting for the outlet temperature sensor 62 displaying completion of heating; directing the kitchenware toward the food ingredient at an appropriate distance, for example, 10 centimeters, and opening the medium spout 27 and the spicery releasing port 28; as the gas 5 flows out fast, the edible oil and the mixed spicery flow out of the medium diffuser 4 due to the pressure difference and are mixed and heated with the gas 5, resulting in the mixed fluid 50; the mixed fluid 50 is homogeneously sprayed on the surface of the food ingredient, whereby the surface of the food ingredient is seared or broiled; during this process, the spicery, the food ingredient, and the appropriate high temperature bring out a desired chemical change, contributing flavor and taste changes of the food ingredient while avoiding overheat from burning the surface.

FIG. 4 illustrates flavor-adding kitchenware according to a second implementation of the disclosure, where those parts identical to the first implementation are omitted. In this implementation, to avoid an unstable cooking effect due to tricky temperature and humidity control of the indoor air, the gas flow driver adopts a high-pressure gas cylinder 30′ filled with a safety gas such as nitrogen, which may not only drive the gas flow, but also facilitate temperature and humidity control; here, the gas flow rate of the high-pressure gas cylinder 30′ may be adjusted via a gas valve. In this implementation, the medium diffuser 4′ is further simplified as a replaceable medium storage 44′ like a typical coffee capsule, an example of which is a seasoned oil capsule, where the user may select appropriate spicery to mix with the medium, with an appropriate volume dependent on a specific recipe to enhance use convenience. An opener 45′ and a heated part 47′, which are fitted with the media storage 44′, are further provided on the base.

In this implementation, when the media storage 44′ and the base are connected in place, the opener 45′opens the media storage 44′ to form a discharge outlet 46′, so that the medium (e.g., seasoned oil) inside can smoothly flow to the heated part 47′ where the medium is heated;

the user may adjust heated temperature of the seasoned oil using the controller 60′ based on the food ingredient. The medium diffuser 4′ is vertically disposed on the base, so that the seasoned oil in the seasoned oil capsule naturally flows downward to the heated part 47′ under the force of gravity, dripping into the gas channel, and mixed with the gas flow, whereby the mixture is jointly blown to the food surface.

FIG. 5 illustrates flavor-adding kitchenware according to a third implementation of the disclosure, where those parts identical to the previous two implementations are omitted. In this implementation, the gas flow driver adopts a high-pressure gas cylinder 30″, and the heater adopts a high-temperature vapor generator 66″, where high-temperature, high-pressure vapor 52″ generated by the high-temperature vapor generator 66″ is the medium, which is preheated and mixed with the gas flow to form a high-temperature mixed fluid. In this implementation, the high-temperature vapor 52″ allows for effective control of the temperature of mixed fluid, preventing the temperature from being excessively high, where the high specific heat capacity of the vapor also facilitates heat transfer to the medium; meanwhile, the high-temperature vapor generator 66′ allows for adjustment to an appropriate high temperature, which is used in cooperation with a gas flow rate-adjustable, high-pressure gas cylinder 30″.

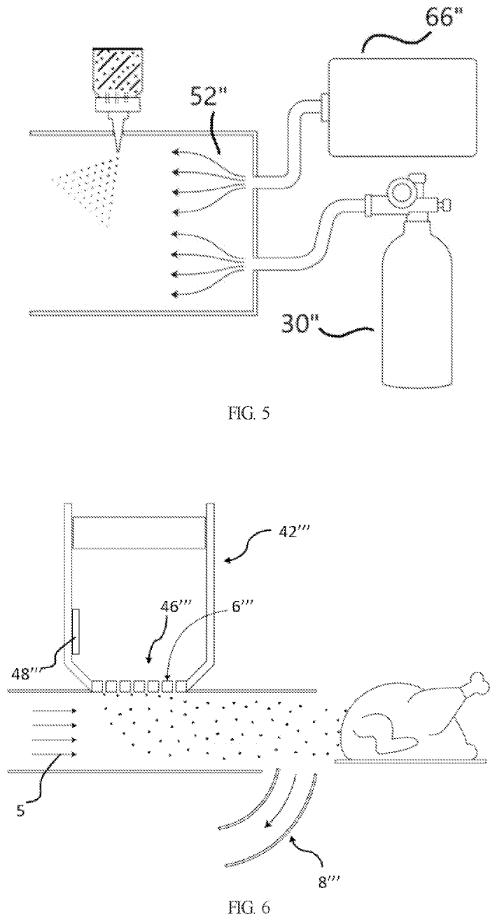

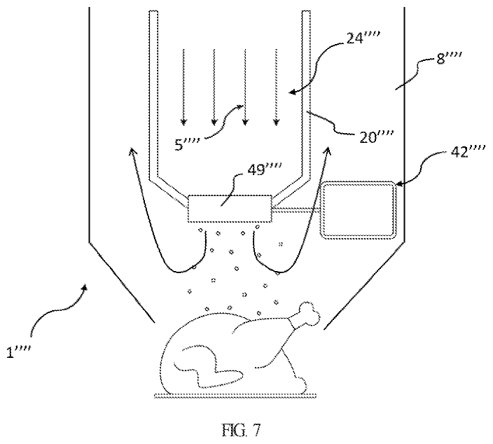

Of course, as those skilled in the art would easily appreciate, even if the medium diffuser adopts for example a vibrating sheet or a bubble generator, the disclosure can be still implemented. FIG. 6 illustrates a fourth implementation of the disclosure, where the oil in the medium canister 42′″ is vibrated and atomized by a vibrating sheet 48′″; a heating sheet 6′″ is disposed at a discharge outlet 46′″. An outer surface of the discharge outlet 46′″ has been subjected to hydrophilic treatment and is formed with a large number of pores, so that the fine oil particles atomized and heated is blown by the gas 5 to the surface of the food ingredient along the direction shown by the arrow in the figure, whereby the surface of the food ingredient is heated; the extra fine oil particles are recovered due to negative pressure applied by a recovery vessel 8′″, which prevents extensive escape of oil droplets during cooking, causing no pollution to the ambience.

FIG. 7 illustrates a fifth implementation of the disclosure, which, for example, uses a sheet of oil screen 49″″ to mask the gas channel 24″″; an edible oil inside the medium canister 42″″ is discharged out via the oil screen 49″″, carried in a slow hot gas flow 5″″, and blown through the oil screen 49″″, so that the edible oil is heated on the oil screen 49″″, blown into oil bubbles or cracked into oil droplets to depart from the oil screen 49″″, and then blown to the surface of the food ingredient to give rise to the Maillard reaction, thereby enhancing flavor of the food ingredient; while the extra oil droplets are sucked back by negative pressure applied by an outer cylinder 8″″, which avoids contamination to the cooking environment; in particular, the flavor-adding kitchenware 1″″ in this implementation only has a front-end opening exposed to the to-be-cooked ingredient, so that the extra medium such as oil droplets may be substantially sealed inside the flavor-adding kitchenware 1″″, thereby reducing cleaning burden after cooking.

In view of the above, the disclosure discloses flavor-adding kitchenware comprising a base, a gas flow driver, a heater, and a medium diffuser, which heats a surface of a food ingredient, giving rising to a Maillard reaction or caramelization reaction. All equivalent effects and other modifications to the disclosure shall fall within the extent of protection of the disclosure.

I/we claim:

1. Flavor-adding kitchenware for a user to heat a surface of a food ingredient having proteins and/or carbohydrates, the flavor-adding kitchenware comprising:
a base;
a gas flow driver operable to drive a gas to flow toward the surface of the food ingredient;
a medium diffuser disposed at the base, operable to diffuse a medium whose specific heat capacity is higher than the gas and mix the medium with the gas which is flowing to form a mixed fluid;
and a heater disposed at the base, operable to heat the gas which is flowing, the medium, or the mixed fluid, till a temperature ranging from 100° C. to 200° C. to contribute a flavor to the surface of the food ingredient.

2. The flavor-adding kitchenware of claim 1, further comprising at least one medium storage that is detachably fitted to the base and an opener disposed at the base, wherein a predetermined amount of the medium is sealed in the medium storage so that when the medium storage is mounted corresponding to the opener, a discharge port connected to the diffuser is formed at the medium storage.

3. The flavor-adding kitchenware of claim 2, wherein the medium storage further comprises a heated portion in thermally conductive connection to the heater, the heated portion being configured to heat the medium stored in the medium storage.

4. The The flavor-adding kitchenware of claim 1, wherein the heater is an electric heater disposed downstream of the gas flow driver.

5. The flavor-adding kitchenware of claim 4, wherein the medium diffuser has a medium spout disposed downstream of the electric heater, and at least one medium canister communicating with the medium spout.

6. The flavor-adding kitchenware of claim 5, wherein the medium diffuser further has a spicery canister, and a spicery releasing port communicating with the spicery canister and corresponding to the medium spout.

7. The flavor-adding kitchenware of claim 1, further comprising an outlet temperature sensor disposed downstream of the heater, the outlet temperature sensor being operable to measure an outlet temperature of the mixed fluid which has been mixed by the medium diffuser and heated by the heater.

8. The flavor-adding kitchenware of claim 7, further comprising a controller, the controller being operable to receive the outlet temperature measured by the outlet temperature sensor, and control, based on the outlet temperature, the gas flow driver and the heater.
